(19) United States
(12) Patent Application Publication
(10) Pub. No.: US 2005/0067962 A1
(43) Pub. Date: Mar. 31, 2005

(54) Plasma display panel

(76) Inventors: Se-Jong Kim, Suwon-si (KR); Seok-Gyun Woo, Suwon-si (KR)

Correspondence Address: MCGUIREWOODS, LLP, 1750 TYSONS BLVD, SUITE 1800, MCLEAN, VA, 22102, US

(21) Appl. No.: 10/948,684

(22) Filed: Sep. 24, 2004

(30) Foreign Application Priority Data
Sep. 26, 2003 (KR) 2003-0066893

(51) Int. Cl. H01J 17/49

(52) U.S. Cl. 313/582; 313/586; 313/587

(57) ABSTRACT

The claimed invention is directed to an improved plasma display panel having an enhanced illumination of blue phosphors. Illustratively, a plasma display panel may include first and second substrates provided with a predetermined gap therebetween. Address electrodes are formed on the first substrate, and a first dielectric layer is formed covering the address electrodes. Barrier ribs are formed on the first dielectric layer to a predetermined height to thereby define discharge cells, and phosphor layers are formed within the discharge cells. Discharge sustain electrodes are formed on the second substrate in a state substantially perpendicular to the address electrodes. A second dielectric layer is formed covering the discharge sustain electrodes. A protection layer is formed coating the second dielectric layer, the protection layer including MgO. The discharge cells and/or the protection layer include a Gd group compound. During use, the Gd group compound produces an enhanced illumination of blue phosphors.

### CROSS REFERENCE TO RELATED APPLICATION

This application claims the benefit of and priority to Korean Patent Application No. 10-2003-0066893 filed in the Korean Intellectual Property Office on Sep. 26, 2003, the entire disclosure of which is incorporated herein by reference.

### BACKGROUND OF THE INVENTION

1. Field of the Invention

The present invention relates to a plasma display panel (PDP), and more particularly, to a PDP having a high level of color purity.

2. Description of the Related Art

A PDP is a display device that utilizes a plasma phenomenon to create and display color images. Each PDP includes millions of cells. Barrier ribs formed between an upper and lower substrate define each discharge cell. A dielectric layer is formed on each of the upper substrate and the lower substrate.

Each cell is intersected by crossed electrodes and contains a gas in a vacuum state. The interior of each cell is lined with a substance that emits visible colors of light when stimulated by ultraviolet radiation. Sustain electrodes (or X electrodes) and scan electrodes (or Y electrodes) are mounted on the upper substrate, and address electrodes are mounted on the lower substrate. In use, a voltage difference applied to the intersecting electrodes excites the gas atoms to release photons which impinge a colored phosphor that lines the interior of the cell. The phosphor absorbs the incident photon and emits visible colored light. By selectively activating various combinations of electrodes, color images may be created.

In the conventional PDP described above, a drive voltage is supplied to the address electrodes and the scan electrodes to thereby affect an address discharge between the same. Wall charges are formed on the dielectric layers of the upper substrate and the lower substrate as a result. Also, in the cells selected by the address discharge, an alternating signal applied to the scan electrodes and the sustain electrodes creates a sustain discharge.

Conventional gases include Xe and Ne. For example, exciting Xe gas to a plasma state releases ultraviolet rays (147 nm; 173 nm) to react with phosphors so that they emit visible light.

Although red and green phosphors glow well in this wavelength range, blue phosphors generally react in an ultraviolet region of 250 nm or higher. Therefore, satisfactory blue illumination does not occur, and this results in poor color reproduction. Thus a need exists for a PDP that produces improved color reproduction, especially with regards to blue illumination.

### SUMMARY OF THE INVENTION

In one exemplary embodiment of the present invention, there is provided a plasma display panel that increases the illumination efficiency of blue phosphors. Illustratively, a plasma display panel includes a first substrate and a second substrate provided substantially parallel to each other with a predetermined gap therebetween. Address electrodes are formed on a surface of the first substrate opposing the second substrate, and a first dielectric layer is formed over an entire surface of the first substrate on which the address electrodes are provided to cover the address electrodes. A plurality of barrier ribs is formed on the first dielectric layer to a predetermined height to thereby define discharge cells, and phosphor layers are formed within the discharge cells.

A plurality of discharge sustain electrodes are formed on a surface of the second substrate opposing the first substrate and in a state substantially perpendicular to the address electrodes. A second dielectric layer is formed over an entire surface of the second substrate on which the discharge sustain electrodes are provided to cover the discharge sustain electrodes. A protection layer is formed coating the second dielectric layer, the protection layer including MgO. One of the discharge cells and the protection layer includes a Gd group compound.

### BRIEF DESCRIPTION OF THE DRAWINGS

The accompanying drawings, which together with the specification, illustrate an exemplary embodiment of the present invention, and, together with the description, serve to explain the principles of the present invention.

FIG. 1 is a partial exploded perspective view of a plasma display panel according to an exemplary embodiment of the present invention.

FIG. 2 is a fluorescence spectrum graph of a plasma display panel of Example 1 of the present invention.

### DETAILED DESCRIPTION

An exemplary embodiment of the present invention will now be described in detail with reference to the accompanying drawings.

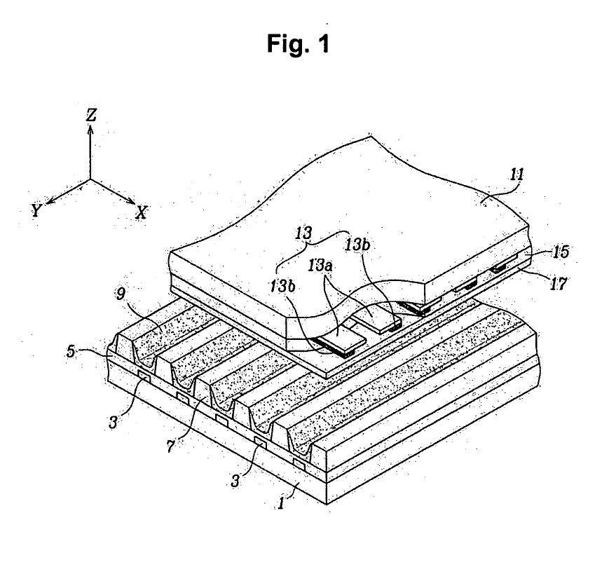

FIG. 1 is a partial exploded perspective view of a plasma display panel (PDP) according to an exemplary embodiment of the present invention.

Illustratively, the PDP includes a first substrate 1 and a second substrate 11 provided opposing one another with a predetermined gap therebetween. Address electrodes 3 are formed in a striped pattern on a surface of the first substrate 1 opposing the second substrate 11. Long axes of the address electrodes 3 are positioned along one direction (direction Y). A dielectric layer 5 is formed over an entire surface of the first substrate 1 on which the address electrodes 3 are provided to cover the same. Barrier ribs 7 are formed on the dielectric layer 5. The barrier ribs 7 are formed in a striped pattern similar to the address electrodes 3, but are positioned to correspond to locations between the address electrodes 3. Red (R), green (G), and blue (B) phosphor layers 9 are formed between the barrier ribs 7. In one embodiment, the phosphor layers 9 also cover opposing surfaces of the barrier ribs 7.

Formed on a surface of the second substrate 11 opposing the first substrate 1 are discharge sustain electrodes 13. The discharge sustain electrodes 13 are comprised of transparent electrodes 13a and bus electrodes 13b, both of which are formed in a striped pattern having long axes that are positioned along a direction (direction X) substantially perpendicular to the long axes of the address electrodes 3. A dielectric layer 15 is formed over an entire surface of the second substrate 11 on which the discharge sustain electrodes 13 are provided to cover the same. A protection layer 17 is formed covering the dielectric layer 15. In one embodiment, MgO is included in or used to produce the protection layer 17.

Areas where the address electrodes 3 and the discharge sustain electrodes 13 intersect define discharge cells. Discharge gas is filled in the discharge cells. Illustrative discharge gases include Xe and Ne. However, other suitable gases known to a person skilled in the art may be used.

In use, an address discharge is created by applying an address voltage Va between one of the address electrodes 3 and one of the discharge sustain electrodes 13. A sustain voltage Vs is then applied between a pair of the discharge sustain electrodes 13 to create a sustain discharge such that ultraviolet rays emitted by the plasma excite the corresponding phosphor layer 9. This phosphor layer 9 emits visible light that passes through the transparent second substrate 11.

A specific additive is used in the exemplary embodiment of the present invention to enhance the illumination efficiency of blue phosphors. In particular, a Gd group compound is used that is extremely stable at high temperatures, and emits light of a wavelength of about 314 nm such that it reacts well to ultraviolet rays that are typically in the wavelength range of about 250 nm or higher. As a result, the illumination efficiency of the blue phosphors increases. Further, since the Gd group compound reacts well with oxygen and hydrogen, this material has the added advantage of removing impurities adhered to the surface of MgO (i.e., the protection layer 17).

The Gd group compound is selected from one or more of the group consisting of Gd₂O₃, GdF₃, Gd₂Te₃, GdCl₃, GdCl₃, 6H₂O, GdBr₃, GdI₂, GdI₃, Gd₂S₃, GdSe, Gd₂Te₃, GdN, and Gd(OH)₃. A Gd group compound is used because of the low melting point of Gd (approximately 150° C.), thereby making it unfeasible to use only the element Gd.

The additive may be mixed with MgO to form the protection layer 17. However, since it is only necessary that the additive receives the aid of secondary electrons generated in the MgO protection layer 17 to emit ultraviolet rays, it is possible for the additive to be positioned anywhere in the discharge region of the PDP and it need not be restricted to the location of the protection layer 17. That is, the additive may be present in the MgO protection layer 17 as a Gd group compound with MgO or in a cluster form, or it may be present in the discharge region of the barrier ribs and phosphors where there is a reaction with excited Xe atoms as an impurity of the main elements of the phosphors and barrier ribs 7, as a material that coats these elements, or as a film.

In one embodiment, if the additive is used in the protection layer 17, the mixing ratio (wt %) of the MgO to the Gd group compound is between 50:50 to 95:5 by weight. If the amount of the Gd group compound exceeds about 50% by weight, there may be an insufficient amount of secondary electron emission of the MgO protection layer 17 by excited Xe atoms. On the other hand, if the amount of the Gd group compound is less than 5% by weight, the advantages of mixing the Gd group compound with MgO are only very minimally realized. In the case where the additive is used in other areas (and not in the protection layer 17), it is necessary to make appropriate adjustments, and there are no specific limitations. Example 1 and a Comparative Example 1 of the present invention will now be described. However, it should be noted that the present invention is not limited to these examples and may include other combinations of materials used by a person skilled in the art to produce embodiments of the invention.

### EXAMPLE 1

In one exemplary experiment, discharge sustain electrodes were formed in a striped pattern on an upper substrate, which was manufactured using soda lime glass. The discharge sustain electrodes were formed using a transparent indium tin oxide conductive material.

Next, a lead group glass paste was coated over an entire surface of the upper substrate on which the discharge sustain electrodes are formed to thereby cover the same. Firing was then performed to thereby result in the formation of a dielectric layer.

Using a sputtering method, a protection layer including MgO and Gd₂O₃ was produced on the dielectric layer to complete the upper substrate.

### COMPARATIVE EXAMPLE 1

Except for manufacturing a protection layer using only MgO, an upper substrate was produced using the same method as described with reference to Example 1 above.

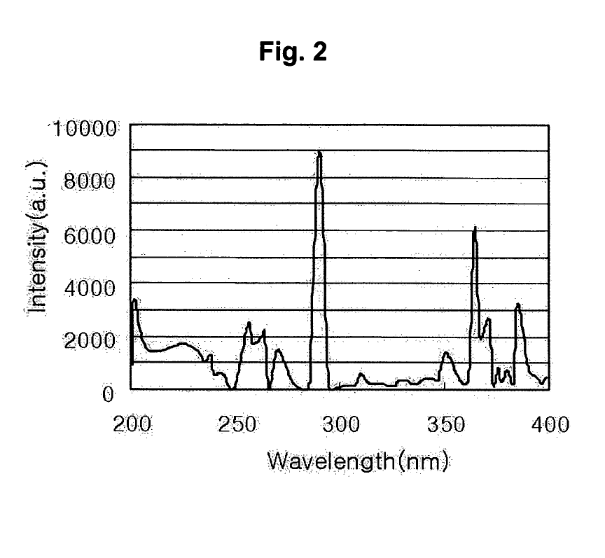

A fluorescence spectrum of the PDP produced according to Example 1 is shown in FIG. 2. As shown in the graph of FIG. 2, the blue phosphors of Example 1 have an enhanced illumination efficiency.

Brightness was measured five times for the PDPs manufactured according to Example 1 and the Comparative Example 1. The results of the measurements appear in Table 1. Brightness measurements were based on a peak white of 1000 cd/m². Peak white refers to a white brightness of an area corresponding to 3% of a center portion of the panel.

TABLE 1

| | Panel 1 | Panel 2 | Panel 3 | Panel 4 | Panel 5 |
|---|---|---|---|---|---|
| | (cd/m²) | (cd/m²) | (cd/m²) | (cd/m²) | (cd/m²) |
| Comparative | 140 | 148 | 142 | 138 | 146 |
| Example 1 | | | | | |
| Example 1 | 200 | 210 | 204 | 198 | 207 |

It is evident from the measurements presented in Table 1 that Example 1, in which Gd₂O₃ is used as an additive for the protection layer, exhibits better brightness characteristics over the Comparative Example 1, in which no additive of Gd₂O₃ is used in the protection layer.

Consequently, use of an additive Gd compound enhances the illumination efficiency of the blue phosphors.

Although an embodiment of the present invention has been described in detail hereinabove in connection with a certain exemplary embodiment, it should be understood that the invention is not limited to the disclosed exemplary embodiment, but, on the contrary is intended to cover various modifications and/or equivalent arrangements included within the spirit and scope of the present invention, as defined in the appended claims.

1. A plasma display panel, comprising:
a first substrate and a second substrate provided substantially parallel to each other with a predetermined gap therebetween;
address electrodes formed on a surface of the first substrate opposing the second substrate;
a first dielectric layer formed over an entire surface of the first substrate on which the address electrodes are provided to cover the address electrodes;
a plurality of barrier ribs formed on the first dielectric layer to a predetermined height to thereby define discharge cells;
phosphor layers formed within the discharge cells;
a plurality of discharge sustain electrodes formed on a surface of the second substrate opposing the first substrate and in a state substantially perpendicular to the address electrodes;
a second dielectric layer formed over an entire surface of the second substrate on which the discharge sustain electrodes are provided to cover the discharge sustain electrodes; and
a protection layer formed coating the second dielectric layer, the protection layer including MgO,
wherein the discharge cells and/or the protection layer include a Gd group compound.

2. The plasma display panel of claim 1, wherein the protection layer includes a Gd group compound.

3. The plasma display panel of claim 2, wherein the mixing ratio (wt %) of the MgO to the Gd group compound is between 50:50 to 95:5 by weight.

4. The plasma display panel of claim 1, wherein the Gd group compound is selected from one or more of the group consisting of Gd₂O₃, GdF₃, Gd₂Te₃, GdCl₃, GdCl₃.6H₂O, GdBr₃, GdI₂, GdI₃, Gd₂S₃, GdSe, Gd₂Te₃, GdN, and Gd(OH)₃.
